(19) United States
(12) Patent Application Publication
(10) Pub. No.: US 2023/0009286 A1
(43) Pub. Date: Jan. 12, 2023

(54) COMPLIANCE TEST METHOD AND SYSTEM FOR RECEIVER AUTONOMOUS INTEGRITY MONITORING (RAIM) PERFORMANCE OF BEIDOU NAVIGATION SATELLITE SYSTEM (BDS) AIRBORNE EQUIPMENT

(71) Applicant: Civil Aviation University of China, Tianjin (CN)

(72) Inventors: Ruihua Liu, Tianjin (CN); Qijin Ding, Tianjin (CN)

(73) Assignee: Civil Aviation University of China, Tianjin (CN)

(21) Appl. No.: 17/642,132

(22) PCT Filed: Oct. 10, 2020
(86) PCT No.: PCT/CN2020/120159

§ 371 Date: Sep. 9, 2022

(30) Foreign Application Priority Data
Sep. 16, 2019 (CN) 201910869545.9

(51) Int. Cl. G01S 19/11; G08G 5/00

(52) U.S. Cl. CPC G01S 19/115; G08G 5/0047

(57) ABSTRACT

The present disclosure provides a compliance test method and system for Receiver Autonomous Integrity Monitoring (RAIM) performance of a BeiDou navigation satellite system (BDS) airborne equipment. The method includes: acquiring BDS almanac parameters and test parameters (101); determining whether the satellites are visible according to the almanac parameters and the test parameters (102); acquiring space-time points when the satellites are visible (103); computing the Horizontal Protection Limit (HPL) of each of the space-time points (104); selecting marginal geometries space-time points according to the HPL (105); test the space-time points and the marginal geometries space-time points to obtain a first test result (106); acquiring the configuration parameters and the BDS almanac of the satellite navigation vector signal generator for the marginal geometries space-time points (107); decoding the configuration parameters and the BDS almanac to obtain the number of visible satellites (108); determining whether the number of visible satellites is greater than a threshold (109); testing the marginal geometries space-time points to obtain the second test result if yes (110); and determining whether the first test result is matched with the second test result (111). The method can check whether the BDS airborne equipment meets airworthiness requirements.

This application claims priority to the Chinese Patent Application No. 201910869545.9, filed with the China National Intellectual Property Administration (CNIPA) on Sep. 16, 2019, and entitled “COMPLIANCE TEST METHOD AND SYSTEM FOR RECEIVER AUTONOMOUS INTEGRITY MONITORING (RAIM) PERFORMANCE OF BEIDOU NAVIGATION SATELLITE SYSTEM (BDS) AIRBORNE EQUIPMENT”, which is incorporated herein by reference in its entirety.

### TECHNICAL FIELD

The present disclosure relates to the technical field of the BeiDou navigation satellite system (BDS) for airworthiness of aircrafts in civil aviation, in particular, to a compliance test method and system for Receiver Autonomous Integrity Monitoring (RAIM) performance of a BDS airborne equipment.

### BACKGROUND ART

BDS is independently researched, designed and constructed by China, and is one of the Global Navigation Satellite systems (GNSS) accepted by the International Committee on Global Navigation Satellite Systems (ICG). With the continuous improvement and development, the BDS has been popularized and applied in all walks of life.

China is now striving to promote the applications of BDS in civil aviation, with an increasing demand for BDS airborne equipments. Therefore, it is of high importance to test and evaluate the airworthiness compliance of the BDS airborne equipments. The integrity is surely more indispensable as one of four core indicators of RNP (Required Navigation Performance) for the navigation systems. At present, the most commonly used integrity monitoring method is the Receiver Autonomous Integrity Monitoring (RAIM), which is an integrity algorithm embedded into the airborne equipment, and performs the statistical consistency test for the receiver based on redundant pseudo-range observers other than external information. According to regulations of the Federal Aviation Administration (FAA), all aviation Global Positioning System (GPS) receivers are provided with the RAIM function. The performance test standard of GPS airborne equipments issued by the Radio Technical Commission for Aeronautics (RTCA) also specifies a method for testing the RAIM alarm performance. However, the applications of the BDS in civil aviation are restricted by the lack of Chinese standards for testing integrity alarm performance of the BDS airborne equipment. The integrity is the safety-critical performance in civil aviation, so how to test and evaluate the RAIM algorithm in the BDS airborne equipment to check whether the integrity of the BDS airborne equipment meets airworthiness requirements is a problem to be solved urgently.

### SUMMARY

An objective of the present disclosure is to provide a compliance test method and system for RAIM performance of a BDS airborne equipment, to test the performance of RAIM algorithm in the BDS airborne equipment.

To achieve the above-mentioned objective, the present disclosure provides the following solutions:

A test method for RAIM performance of a BDS airborne equipment includes:

acquiring BDS almanac parameters and test parameters, the test parameters including: test locations, sampling interval, mask angle and flight phase;

determining whether satellites are visible according to the BDS almanac parameters and the test parameters;

counting, when the satellites are visible, distributions of the visible satellites at the test locations according to the sampling interval to obtain space-time points;

computing the Horizontal Protection Limit (HPL) of each of the space-time points;

selecting space-time points each having the HPL within a preset value range as marginal geometries space-time points;

testing the space-time points and the marginal geometries space-time points to obtain a first test result;

acquiring the configuration parameters and the BDS almanac of the satellite navigation vector signal generator for the marginal geometries space-time points;

decoding the configuration parameters and the BDS almanac to obtain the number of visible satellites;

determining whether the number of visible satellites is greater than the threshold number of visible satellites;

testing the marginal geometries space-time points to obtain a second test result if yes;

determining whether the first test result is matched with the second test result; and

determining that the RAIM performance meets integrity requirements if yes.

Optionally, the acquiring BDS almanac parameters may specifically include:

receiving the BDS almanac with a BDS receiver; and

decoding the BDS almanac to obtain the almanac parameters.

Optionally, the determining whether satellites are visible according to the BDS almanac parameters and the test parameters may specifically include:

computing an elevation angle of each of the satellites relative to a selected test geographic location according to the BDS almanac parameters;

determining whether the elevation is greater than the mask angle;

determining that the satellite is visible if yes; and

determining that the satellite is invisible if no.

Optionally, the step of testing the space-time points and the marginal geometries space-time points to obtain a first test result may specifically include:

performing a fault-free random Monte Carlo experiment on each of the space-time points; and

performing a ramp fault detection and a step fault detection on each of the marginal geometries space-time points.

Optionally, the step of testing the marginal geometries space-time points to obtain a second test result may specifically include:

performing a ramp fault detection and a step fault detection on each of the marginal geometries space-time points.

Optionally, after the step of computing the HPL of each of the space-time points, the method may further include:

determining whether the HPL is less than the Horizontal Alarm Limit (HAL);

determining that the RAIM algorithm is available if yes; and

determining that the RAIM algorithm is unavailable if no.

Optionally, after the step of decoding the configuration parameters to obtain the number of visible satellites, the method may further include:

determining whether the number of visible satellites is greater than the threshold number of visible satellites;

determining that the RAIM algorithm is available if yes; and

determining that the RAIM algorithm is unavailable if no.

The present disclosure further provides a test system for RAIM performance of a BDS airborne equipment, including:

a first parameter acquisition module, configured to acquire BDS almanac parameters and test parameters, the test parameters including test locations, sampling interval, mask angle and flight phase;

a first determination module, configured to determine whether satellites are visible according to the BDS almanac parameters and the test parameters;

a counting module, configured to count, when the satellites are visible, distributions of the visible satellites at the test locations according to the sampling interval to obtain space-time points;

an HPL computation module, configured to compute the HPL of each of the space-time points;

a selection module, configured to select space-time points each having the HPL within a preset value range as marginal geometries space-time points;

a first test module, configured to test the space-time points and the marginal geometries space-time points to obtain a first test result;

a second parameter acquisition module, configured to acquire the configuration parameters and the BDS almanac of the satellite navigation vector signal generator for the marginal geometries space-time points;

an analysis module, configured to decode the configuration parameters and the BDS almanac to obtain the number of visible satellites;

a second determination module, configured to determine whether the number of visible satellites is greater than the threshold number of visible satellites;

a second test module, configured to test the marginal geometries space-time points to obtain a second test result when determining that the number of visible satellites is greater than the threshold number of visible satellites;

a third determination module, configured to determine whether the first test result is matched with the second test result; and

a second result determination module, configured to determine that the RAIM performance meets integrity requirements when the first test result is matched with the second test result.

Optionally, the first parameter acquisition module may specifically include:

a receiving unit, configured to receive the BDS almanac with a BDS receiver; and

an analysis unit, configured to decode the BDS almanac to obtain the almanac parameters.

Optionally, the first determination module may include:

an elevation angle computation unit, configured to compute an elevation angle of each of the satellites relative to a selected test geographic location according to the BDS almanac parameters;

a determination unit, configured to determine whether the elevation is greater than the mask angle; and

a result determination unit, configured to determine that the satellite is visible when the elevation is greater than the mask angle; and determine that the satellite is invisible when the elevation is less than the mask angle.

Based on specific embodiments provided by the present disclosure, the present disclosure has the following technical effects:

The present disclosure provides a compliance test method and system for RAIM performance of a BDS airborne equipment. The method includes: acquiring BDS almanac parameters and test parameters; determining whether satellites are visible according to the almanac parameters and the test parameters; acquiring space-time points when the satellites are visible, and computing the HPL of each of the space-time points; selecting marginal geometries space-time points according to the HPL; testing the space-time points and the marginal geometries space-time points to obtain a first test result; acquiring the configuration parameters and the BDS almanac of the satellite navigation vector signal generator for the marginal geometries space-time points; decoding the configuration parameters and the BDS almanac to obtain the number of visible satellites; determining whether the number of visible satellites is greater than the threshold, testing the marginal geometries space-time points to obtain a second test result if yes; and determining whether the first test result is matched with the second test result. In this way, the compliance test method and system can help check whether the integrity of the BDS airborne equipment meets airworthiness requirements.

### BRIEF DESCRIPTION OF THE DRAWINGS

To explain the technical solutions in embodiments of the present disclosure or in the prior art more clearly, the accompanying drawings required in the embodiments will be described below in brief. Apparently, the accompanying drawings in the following description show merely some embodiments of the present disclosure, and other drawings may be derived from these accompanying drawings by a person of ordinary skill in the art without creative efforts.

FIG. 1 illustrates a flow chart of a compliance test method for RAIM performance of a BDS airborne equipment according to an embodiment of the present disclosure; and

FIG. 2 illustrates a structural block diagram of a compliance test system for RAIM performance of a BDS airborne equipment according to an embodiment of the present disclosure.

### DETAILED DESCRIPTION OF THE EMBODIMENTS

The technical solutions of the embodiments of the present disclosure are clearly and completely described below with reference to the accompanying drawings in the embodiments of the present disclosure. Apparently, the described embodiments are merely a part rather than all of the embodiments of the present disclosure. Based on the embodiments of the present disclosure, all other embodiments obtained by the person of ordinary skill in the art without creative efforts shall fall within the protection scope of the present disclosure.

An objective of the present disclosure is to provide a compliance test method and system for RAIM performance of a BDS airborne equipment, to test and evaluate the RAIM algorithm in the BDS airborne equipment, and check whether the integrity of the BDS airborne equipment meets airworthiness requirements.

To make the objective, features, and advantages of the present disclosure clearer and more comprehensible, the present disclosure will be further described in detail below in conjunction with the accompanying drawings and specific implementations.

### EMBODIMENTS

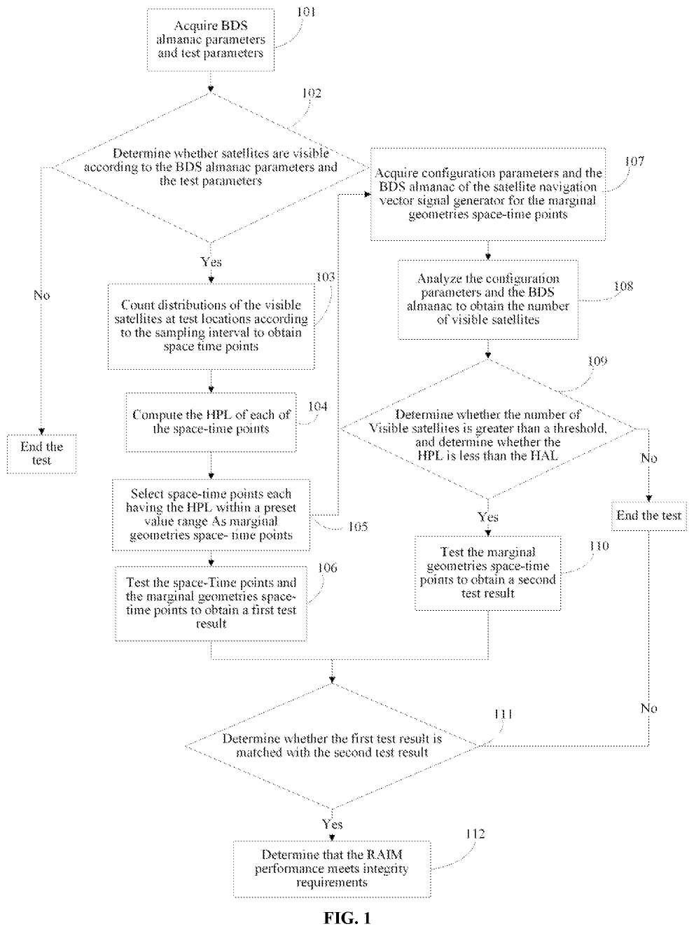

As shown in FIG. 1, the present disclosure provides a compliance test method for RAIM performance of a BDS airborne equipment, specifically including the following steps:

101: BDS almanac parameters and test parameters are acquired. The test parameters include test locations, sampling interval, mask angle and flight phase. Different flight phases correspond to different integrity requirements, such as HALs.

The BDS almanac parameters are specifically acquired as follows:

The BDS almanac is received with a BDS receiver.

The BDS almanac is decoded to obtain the almanac parameters.

102: Whether satellites are visible are determined according to the BDS almanac parameters and the test parameters, specifically including:

An elevation angle of each of the satellites relative to a selected test geographic location is computed according to the BDS almanac parameters.

Whether the elevation is greater than the mask angle is determined.

It is determined that the satellite is visible if yes.

It is determined that the satellite is invisible if no.

103: When the satellites are visible, distributions of the visible satellites at the test locations are counted according to the sampling interval to obtain space-time points.

104: The HPL of each of the space-time points is computed.

Whether the HPL is less than the HAL is determined.

It is determined that the RAIM algorithm is available if yes.

It is determined that the RAIM algorithm is unavailable if no.

105: If the RAIM algorithm is available, space-time points each having the HPL within a preset value range are selected as marginal geometries space-time points.

106: The space-time points and the marginal geometries space-time points are tested to obtain a first test result, specifically including:

A fault-free random Monte Carlo experiment is performed on each of the space-time points.

A ramp fault detection and a step fault detection are performed on each of the marginal geometries space-time points.

107: The configuration parameters and the BDS almanac of the satellite navigation vector signal generator for the marginal geometries space-time points are acquired.

108: The configuration parameters and the BDS almanac are decoded to obtain the number of visible satellites.

109: Whether the number of visible satellites is greater than the threshold number of visible satellites is determined.

It is determined that the RAIM algorithm is available if yes, and the HPL of each of space-time points is computed.

Whether the HPL is less than the HAL is determined.

110: It is determined that the RAIM algorithm is available if yes, and the marginal geometries space-time points are tested to obtain a second test result, specifically including:

A ramp fault detection and a step fault detection are performed on each of the marginal geometries space-time points.

111: Whether the first test result is matched with the second test result is determined.

112: It is determined that the RAIM performance meets integrity requirements if yes.

The specific implementation process is as follows:

The method includes an offline test and an online test.

The offline test includes the following steps:

S1: The BDS receiver receives the BDS almanac through an antenna, and stores the received BDS almanac to the data storage unit according to the American Standard Code for Information Interchange (ASCII) format.

S2: The BDS almanac is transmitted to the message analysis unit, and then decoded to obtain the almanac parameters, such as the satellite number, almanac reference time, square root of semi-major axis, eccentricity, argument of perigee, mean anomaly at reference time, right ascension of ascending nod, change rate for the right ascension of ascending nod, and change of the reference inclination, etc.

S3: The test parameters, including test locations, sampling interval, mask angle and flight phase, are acquired.

The flight test phase includes the non-precision approach (NPA) phase, the terminal phase, and the en-route phase. Different flight phases correspond to different integrity requirements, specifically including HALs, alarm time, false alarm rates (FARs), missing alarm rate (MARs), etc. According to the flight phase selected by the user, the system automatically configures corresponding integrity requirements.

S4: The locations of satellites are resolved according to the almanac parameters in S2, and the elevation angle of each of the satellites relative to the selected test geographic location is computed to determine whether the satellite is visible. When the elevation is greater than the input mask angle in S3, the satellite is visible and is called the visible satellite.

Distributions of visible satellites at the test locations are counted according to the specified sampling interval h in S3; and after 24 h, there are 24/h×N space-time points in total, N being the number of test locations (N=12 indicates the number of test locations).

The space-time points include the test locations, distributions of visible satellites at present time, test time, etc.

HPLs corresponding to all 24/h×12 space-time points are computed, and compared with the HALs in S3. If HPL>HAL, the RAIM algorithm at the corresponding space-time point is unavailable.

The HPL is specifically computed as follows:

HPL=Slopeₘₐₓ×σ×\sqrt{λ}

Slopeₘₐₓ=max{\sqrt{(A₁ᵢ²+A₂ᵢ²)/Sᵢᵢ}}

A=(_i G^{T}G)⁻¹G^{T}

G is a linear observation matrix, specifically, an n×4 matrix; and A represents a matrix.

S=I−G(G^{T}G)⁻¹G^{T},

where, I is an nxn unit matrix, and S represents a matrix.

In the above Eqs., i represents an ith visible satellite; slopeₘₐₓ represents a maximum value of a characteristic slope of the visible satellite; A₁ᵢ A₂ᵢ are an ith column of elements on a first row and an ith column of elements on a second row in A, respectively; Sᵢᵢ is an ith column of elements on an ith row in S, values on the main diagonal being 1, and other values being 0; λ is a decentralization parameter; σ is a standard deviation of a user equivalent range error (UERE); and n is the number of visible satellites.

The HPL is the Horizontal Protection Limit and represents the distribution of the satellite. It is used to determine the availability of the RAIM algorithm.

The 12 test geographic locations include Kashi, Amsterdam Island, Golmud, Cocos Island, Baise, Perth, Sandakan, Bum Island, Busan, Borroloola, Tokyo, and Melbourne.

S5: The space-time points obtained when the RAIM algorithm is available in S4 are sorted according to HPLs, and ten of them that having maximum HPLs are selected as marginal geometries space-time points.

S6: A fault-free random Monte Carlo experiment is performed for 100 times on each of the space-time points obtained when the RAIM algorithm is available in S4 (namely, HPL<HAL), the number of alarms is counted to compute the FAR, and a test result is displayed on a display unit in the combination of the figure and the text.

S7: A ramp fault detection and a step fault detection are respectively performed on each of the marginal geometries space-time points in S5.

The ramp fault detection is implemented by adding a ramp pseudo-range error having a slope of 5 m/s to the satellite that is most difficultly to be detected and performing the random Monte Carlo experiment for 1,000 times.

The step fault detection is implemented by adding a step pseudo-range error having an amplitude of 1,000 m to the satellite that is most difficultly to be detected and performing the random Monte Carlo experiment for 1,000 times.

The satellite that is most difficultly to be detected is the satellite that have the maximum value of Slope ^{Slope}ₘₐₓ in S4.

S8: S7 is repeated, until the ten marginal geometries space-time points are tested completely, the number of normal detection points, the number of false alarms and the number of missing alarms are counted to compute the detection probability, the FAR and the MAR, and the test result is displayed in the combination of the figure and the text.

S9: The test result is counted to generate an offline test report.

The online test method specifically includes the following steps.

S1: One marginal geometries space-time point acquired in the offline test method is selected, and parameters including the test time, the test location and the loaded BDS almanac are configured for the satellite navigation vector signal generator. The test time should be at least five minutes earlier than the time of the selected marginal geometries space-time point, such that the BDS receiver can track all satellites stably when the error is added.

The signal generator simulates space and time information of the test location according to the configured parameters, and transmits the information to the BDS receiver via radio-frequency (RF) signal.

S2: The RF signal from the satellite navigation vector signal generator is received, and the information included in the RF signal is transmitted to the message analysis unit.

S3: The information acquired in S2 is extracted to obtain information of visible satellites, pseudo-range information, and location information of the receiver.

S4: The availability of the RAIM algorithm is preliminarily determined according to the extracted information of visible satellites.

If there are less than five visible satellites, the RAIM algorithm is unavailable, the test is ended, and the alarm is sent.

If there are five visible satellites or more, the HPL is computed; and if the HPL is greater than the HAL, the RAIM algorithm is unavailable, the test is ended, and the alarm is sent;

or otherwise, the RAIM algorithm is available.

S5: A ramp fault detection and a step fault detection are respectively performed on the marginal geometries space-time point if the RAIM algorithm is available.

The ramp fault detection is implemented by adding a ramp pseudo-range error having a slope of 5 m/s to the satellite that is most difficultly to be detected, performing the fault detection, recording the test result, and displaying the test result in the combination of the figure and text.

The step fault detection is implemented by adding the step pseudo-range error having an amplitude of 1,000 m to the satellite that is most difficultly to be detected, performing the fault detection, recording the test result, and displaying the test result in the combination of the figure and text.

S6: steps S1 to S5 in the online test are repeated, until ten marginal geometries space-time points are tested completely.

S7: The test result is counted to generate an online test report.

S8: The offline test report and the online test report are comparatively decoded to check whether the online test result is matched with the offline test result.

The RAIM algorithm meets the integrity requirements if yes;

or otherwise, the RAIM algorithm does not meet the integrity requirements.

Based on the specific embodiment provided by the present disclosure, the present disclosure has the following technical effects: By resolving the locations of the satellites with the BDS almanac, performing an offline test with a software simulate, and performing an online test on a test bed in combination with the satellite navigation vector signal generator and the BDS receiver, the compliance test method for RAIM performance of a BDS airborne equipment provided by the present disclosure tests and evaluates the performance of the RAIM algorithm in the BDS airborne equipment to check whether the RAIM algorithm meets the integrity requirements.

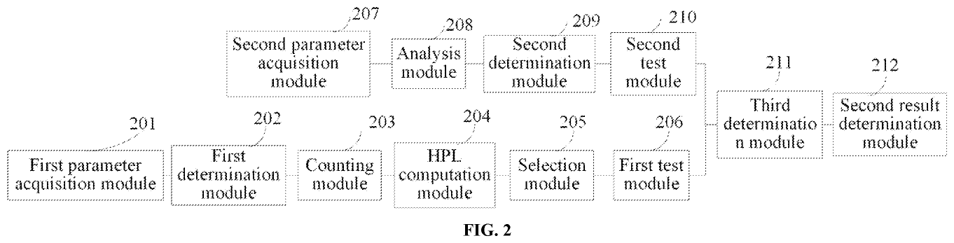

As shown in FIG. 2, the present disclosure further provides a compliance test system for RAIM performance of a BDS airborne equipment, including a first parameter acquisition module 201, a first determination module 202, a counting module 203, an HPL computation module 204, a selection module 205, a first test module 206, a second parameter acquisition module 207, an analysis module 208, a second determination module 209, a second test module 210, a third determination module 211, and a second result determination module 212.

The first parameter acquisition module 201 is configured to acquire BDS almanac parameters and test parameters, the test parameters including test locations, sampling interval, mask angle and flight phase.

The first parameter acquisition module 201 specifically includes:

a receiving unit, configured to receive the BDS almanac with a BDS receiver; and

an analysis unit, configured to decode the BDS almanac to obtain the almanac parameters.

The first determination module 202 is configured to determine whether satellites are visible according to the BDS almanac parameters and the test parameters.

The first determination module 202 includes:

an elevation angle computation unit, configured to compute an elevation angle of each of the satellites relative to a selected test geographic location according to the BDS almanac parameters;

a first determination unit, configured to determine whether the elevation is greater than the mask angle; and

a result determination unit, configured to determine that the satellite is visible when the elevation is greater than the mask angle; and determine that the satellite is invisible when the elevation is less than the mask angle.

The counting module 203 is configured to count, when the satellites are visible, distributions of the visible satellites at the test locations according to the sampling interval to obtain space-time points.

The HPL computation module 204 is configured to compute the HPL of each of the space-time points.

The selection module 205 is configured to select space-time points each having the HPL within a preset value range as marginal geometries space-time points.

The first test module 206 is configured to test the space-time points and the marginal geometries space-time points to obtain a first test result.

The first test module 206 includes:

a random Monte Carlo test unit, configured to perform a fault-free random Monte Carlo experiment on each of the space-time points;

a first ramp fault test unit, configured to perform a ramp fault detection on each of the marginal geometries space-time points; and

a first step fault test unit, configured to perform a step fault detection on each of the marginal geometries space-time points.

The second parameter acquisition module 207 is configured to acquire the configuration parameters and the BDS almanac of the satellite navigation vector signal generator for the marginal geometries space-time points.

The analysis module 208 is configured to decode the configuration parameters and the BDS almanac to obtain the number of visible satellites.

The second determination module 209 is configured to determine whether the number of visible satellites is greater than the threshold number of visible satellites.

The second test module 210 is configured to test the marginal geometries space-time points to obtain a second test result when determining that the number of visible satellites is greater than the threshold number of visible satellites.

The second test module 210 includes:

a second ramp fault test unit, configured to perform a ramp fault detection on each of the marginal geometries space-time points; and

a second step fault test unit, configured to perform a step fault detection on each of the marginal geometries space-time points.

The third determination module 211 is configured to determine whether the first test result is matched with the second test result.

The second result determination module 212 is configured to determine that the RAIM performance meets integrity requirements when the first test result is matched with the second test result.

The system further includes: a first result determination module, and a second result determination module.

The first result determination module is configured to determine whether the RAIM algorithm is available according to the HPL of each of the space-time points, the first result determination module including:

a second determination unit, configured to determine whether the computed HPL of each of the space-time points is less than the HAL; and

a first algorithm determination unit, configured to determine whether the RAIM algorithm is available according to whether the HPL of each of the space-time points is less than the HAL.

The second result determination module is configured to compute the HPL of each of the marginal geometries space-time points when the number of visible satellites is greater than the threshold number of visible satellites, determine whether the HPL of each of the marginal geometries space-time points is less than the HAL, and determine whether the RAIM algorithm is available.

The second result determination module specifically includes:

an HPL computation unit, configured to compute the HPL of each of the marginal geometries space-time points when the number of visible satellites is greater than the threshold number of visible satellites;

a third determination unit, configured to determine whether the HPL of each of the marginal geometries space-time points is less than the HAL; and

a second algorithm determination unit, configured to determine whether the RAIM algorithm is available according to whether the HPL of each of the marginal geometries space-time points is less than the HAL.

Specific embodiments are used to expound the principle and implementations of the present disclosure. The description of these embodiments is merely used to assist in understanding the method of the present disclosure and its core conception. In addition, those of ordinary skill in the art can make modifications in terms of specific implementations and scope of application based on the conception of the present disclosure. In conclusion, the content of this specification should not be construed as a limitation to the present disclosure.

The above embodiments are provided merely for an objective of describing the present disclosure and are not intended to limit the scope of the present disclosure. The scope of the present disclosure is defined by the appended claims. Various equivalent replacements and modifications made without departing from the spirit and scope of the present disclosure should all fall within the scope of the present disclosure.

What is claimed is:

1. A test method for Receiver Autonomous Integrity Monitoring (RAIM) performance of a BeiDou navigation satellite system (BDS) airborne equipment, comprising:
acquiring BDS almanac parameters and test parameters, the test parameters comprising sampling interval, mask angle and flight phase;
determining whether satellites are visible according to the BDS almanac parameters and the test parameters;
counting, when the satellites are visible, distributions of the visible satellites at test locations according to the sampling interval to obtain space-time points;
computing the Horizontal Protection Limit (HPL) of each of the space-time points;
selecting space-time points each having the HPL within a preset value range as marginal geometries space-time points;
testing the space-time points and the marginal geometries space-time points to obtain a first test result;
acquiring the configuration parameters and the BDS almanac of the satellite navigation vector signal generator for the marginal geometries space-time points;
decoding the configuration parameters and the BDS almanac to obtain the number of visible satellites;
determining whether the number of visible satellites is greater than the threshold number of visible satellites;
testing the marginal geometries space-time points to obtain a second test result if yes;
determining whether the first test result is matched with the second test result; and
determining that the RAIM performance meets integrity requirements if yes.

2. The test method for RAIM performance of a BDS airborne equipment according to claim 1, wherein the acquiring BDS almanac parameters specifically comprises:
receiving the BDS almanac with a BDS receiver; and
decoding the BDS almanac to obtain the almanac parameters.

3. The test method for RAIM performance of a BDS airborne equipment according to claim 1, wherein the determining whether satellites are visible according to the BDS almanac parameters and the test parameters specifically comprises:
computing an elevation angle of each of the satellites relative to a selected test geographic location according to the BDS almanac parameters;
determining whether the elevation is greater than the mask angle;
determining that the satellite is visible if yes; and
determining that the satellite is invisible if no.

4. The test method for RAIM performance of a BDS airborne equipment according to claim 1, wherein the step of testing the space-time points and the marginal geometries space-time points to obtain a first test result specifically comprises:
performing a fault-free random Monte Carlo experiment on each of the space-time points; and
performing a ramp fault detection and a step fault detection on each of the marginal geometries space-time points.

5. The test method for RAIM performance of a BDS airborne equipment according to claim 1, wherein the step of testing the marginal geometries space-time points to obtain a second test result specifically comprises:
performing a ramp fault detection and a step fault detection on each of the marginal geometries space-time points.

6. The test method for RAIM performance of a BDS airborne equipment according to claim 1, after the step of computing the HPL of each of the space-time points, further comprising:
determining whether the HPL is less than the Horizontal Alarm Limit (HAL);
determining that the RAIM algorithm is available if yes; and
determining that the RAIM algorithm is unavailable if no.

7. The test method for RAIM performance of a BDS airborne equipment according to claim 1, after the step of decoding the configuration parameters to obtain the number of visible satellites, further comprising:
determining whether the number of visible satellites is greater than the threshold;
determining that the RAIM algorithm is available if yes;
determining that the RAIM algorithm is unavailable if no;
computing the HPL of each of space-time points if the RAIM algorithm is available, and determining whether the HPL is less than the HAL;
determining that the RAIM algorithm is available if yes; and
determining that the RAIM algorithm is unavailable if no.

8. A test system for Receiver Autonomous Integrity Monitoring (RAIM) performance of a BeiDou navigation satellite system (BDS) airborne equipment, comprising:
a first parameter acquisition module, configured to acquire BDS almanac parameters and test parameters, the test parameters comprising sampling interval, mask angle and flight phase;
a first determination module, configured to determine whether satellites are visible according to the BDS almanac parameters and the test parameters;
a counting module, configured to count, when the satellites are visible, distributions of the visible satellites at test locations according to the sampling interval to obtain space-time points;
a Horizontal Protection Limit (HPL) computation module, configured to compute the HPL of each of the space-time points;
a selection module, configured to select space-time points each having the HPL within a preset value range as marginal geometries space-time points;
a first test module, configured to test the space-time points and the marginal geometries space-time points to obtain a first test result;
a second parameter acquisition module, configured to acquire the configuration parameters and the BDS almanac of the satellite navigation vector signal generator for the marginal geometries space-time points;
an analysis module, configured to decode the configuration parameters and the BDS almanac to obtain the number of visible satellites;
a second determination module, configured to determine whether the number of visible satellites is greater than the threshold number of visible satellites;
a second test module, configured to test the marginal geometries space-time points to obtain a second test result when determining that the number of visible satellites is greater than the threshold number of visible satellites;
a third determination module, configured to determine whether the first test result is matched with the second test result; and
a second result determination module, configured to determine that the RAIM performance meets integrity requirements when the first test result is matched with the second test result.

9. The test system for RAIM performance of a BDS airborne equipment according to claim 8, wherein the first parameter acquisition module specifically comprises:
a receiving unit, configured to receive the BDS almanac with a BDS receiver; and
an analysis unit, configured to decode the BDS almanac to obtain the almanac parameters.

10. The test system for RAIM performance of a BDS airborne equipment according to claim 8, wherein the first determination module comprises:
an elevation angle computation unit, configured to compute an elevation angle of each of the satellites relative to a selected test geographic location according to the BDS almanac parameters;
a determination unit, configured to determine whether the elevation is greater than the mask angle; and
a result determination unit, configured to determine that the satellite is visible when the elevation is greater than the mask angle; and determine that the satellite is invisible when the elevation is less than the mask angle.
